(19) United States
(12) Patent Application Publication
(10) Pub. No.: US 2023/0386439 A1
(43) Pub. Date: Nov. 30, 2023

(54) INFORMATION PROCESSING SYSTEM, ELECTRONIC MUSICAL INSTRUMENT, INFORMATION PROCESSING METHOD, AND TRAINING MODEL GENERATING METHOD

(71) Applicant: YAMAHA CORPORATION, Hamamatsu-shi (JP)

(72) Inventors: Tomoya TANABE, Hamamatsu-shi (JP); Masafumi SOBAJIMA, Hamamatsu-shi (JP)

(21) Appl. No.: 18/449,024

(22) Filed: Aug. 14, 2023

Related U.S. Application Data
(63) Continuation of application No. PCT/JP2022/002231, filed on Jan. 21, 2022.

(30) Foreign Application Priority Data
Feb. 16, 2021 (JP) 2021-022430

(51) Int. Cl. G10H 1/053; G10H 1/34

(52) U.S. Cl. CPC G10H 1/053; G10H 1/34

(57) ABSTRACT

An electronic musical instrument is configured to: (a) acquire input data that includes habit data indicative of a playing habit of a user in playing a musical instrument; (b) generate correction data by inputting the acquired input data into at least one trained model that learns a relationship between training input data and training correction data; and (c) correct, using the generated correction data, at least one first intensity characteristic representative of a relationship between: (i) a playing intensity in playing the musical instrument by the user; and (ii) a sound intensity of a musical sound output in response to playing of the musical instrument.

### CROSS REFERENCE TO RELATED APPLICATIONS

This application is a Continuation Application of PCT Application No. PCT/JP2022/002231 filed on Jan. 21, 2022, and is based on and claims priority from Japanese Patent Application No. 2021-022430 filed on Feb. 16, 2021, the entire contents of each of which are incorporated herein by reference.

### BACKGROUND

### Field of the Invention

This disclosure relates to control of a relationship between a playing intensity in playing an electronic musical instrument by a user and a musical sound intensity generated by the electronic musical instrument.

A variety of techniques are known in the art for controlling intensity characteristics, namely relationships between playing intensity and musical sound intensity. For example, Japanese Patent Application Laid-Open Publication No. JP 2003-122360 discloses generating a touch curve from a maximum and an average value corresponding to a key depression intensity. Furthermore, Japanese Patent Application Laid-Open Publication No. JP 2008-64983 discloses controlling a touch curve based on detection characteristic information specific to a musical keyboard of an electronic musical instrument.

In reality, however, user playing habits in playing a musical instrument make it difficult to determine appropriate intensity characteristics.

### SUMMARY

In view of the circumstances described above, an object of one aspect of this disclosure is to determine appropriate intensity characteristics while taking into account user playing habits in playing a musical instrument.

To achieve the above-stated object, an information processing system according to one aspect of this disclosure includes: at least one memory that stores a program; and at least one processor that executes the program to: acquire input data that includes habit data indicative of a playing habit of a user in playing a musical instrument; generate correction data by inputting the acquired input data into at least one trained model that learns a relationship between training input data and training correction data; and correct, using the generated correction data, at least one first intensity characteristic representative of a relationship between: (i) a playing intensity in playing the musical instrument by the user; and (ii) a sound intensity of a musical sound output in response to playing of the musical instrument.

An electronic musical instrument according to one aspect of this disclosure includes: (a) at least one memory that stores a program; (b) at least one processor that executes the program to: acquire input data that includes habit data indicative of a playing habit of a user in playing the electronic musical instrument; generate correction data by inputting the acquired input data into at least one trained model that learns a relationship between training input data and training correction data; correct, using the generated correction data, at least one first intensity characteristic representative of a relationship between: (i) a playing intensity in playing the electronic musical instrument by the user; and (ii) a sound intensity of a musical sound output in response to playing of the electronic musical instrument; and set a second intensity characteristic by correcting the at least one first intensity characteristic; (c) a playing device configured to receive playing input by the user; and (d) a playback controller configured to control a playback system to play back a musical sound dependent on the received playing input using the second intensity characteristic.

A computer-implemented information processing method according to one aspect of this disclosure includes: acquiring input data that includes habit data indicative of a playing habit of a user in playing a musical instrument; generating correction data by inputting the acquired input data into at least one trained model that learns a relationship between training input data and training correction data; and correcting, using the generated correction data, at least one first intensity characteristic representative of a relationship between: (i) a playing intensity in playing the musical instrument by the user; and (ii) a sound intensity of a musical sound output in response to playing of the musical instrument.

A computer-implemented training model generating method according to one aspect of this disclosure includes: acquiring a plurality of training data including a combination of: (i) training input data that includes habit data indicative of a playing habit of a player in playing a musical instrument; and (ii) training correction data to correct an intensity characteristic, wherein the intensity characteristic represents a relationship between: (i) a playing intensity in playing the musical instrument by the player; and (ii) a sound intensity of a musical sound output in response to playing of the musical instrument, and establishing, by machine learning using the plurality of training data, at least one trained model that learns a relationship between the training input data and the training correction data.

### BRIEF DESCRIPTION OF DRAWINGS

FIG. 1 is a block diagram showing an example of a configuration of an electronic musical instrument according to a first embodiment.

FIG. 2 is a block diagram showing a functional configuration of the electronic musical instrument.

FIG. 3 is a diagram showing intensity characteristics.

FIG. 4 is a flow chart showing a playback procedures.

FIG. 5 is a schematic diagram showing input data.

FIG. 6 is a flow chart showing an example of setting procedures.

FIG. 7 is a block diagram showing an example of a configuration of a machine learning system.

FIG. 8 is a block diagram showing an example of a functional configuration of the machine learning system.

FIG. 9 is a flow chart showing an example of learning procedures.

FIG. 10 is an explanatory diagram showing a corrector according to a third embodiment.

FIG. 11 is an explanatory diagram showing a generator according to a fourth embodiment.

FIG. 12 is a block diagram showing an example of a configuration of a performance system according to a fifth embodiment.

FIG. 13 is a flow chart showing setting procedures according to the fifth embodiment.

FIG. 14 is a block diagram showing an example of a configuration of a performance system according to a sixth embodiment.

FIG. 15 is a block diagram showing an example of a configuration of a performance system according to a seventh embodiment.

FIG. 16 is a side view of a key of a musical keyboard (playing device) according to an eighth embodiment.

FIG. 17 is a circuit diagram showing an example of a configuration of a detector.

### DESCRIPTION OF THE EMBODIMENTS

### A: First Embodiment

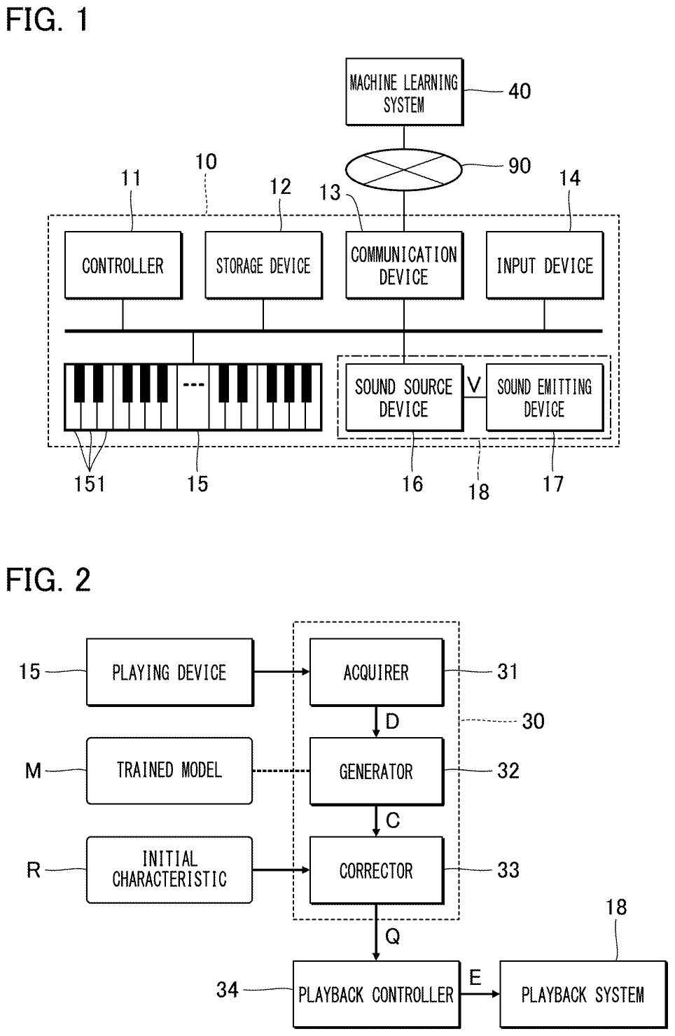

FIG. 1 is a block diagram showing an example of a configuration of an electronic musical instrument 10 according to the first embodiment. The electronic musical instrument 10 plays back musical sound representative of a user's playing. The electronic musical instrument 10 includes a controller 11, a storage device 12, a communication device 13, an input device 14, a playing device 15, a sound source device 16, and a sound emitting device 17. The electronic musical instrument 10 may be implemented not only as a single device, but also as more than one independent device.

The controller 11 comprises one or more processors that control components of the electronic musical instrument 10. Specifically, the controller 11 is constituted of one or more processors, such as a Central Processing Unit (CPU), a Sound Processing Unit (SPU), a Digital Signal Processor (DSP), a Field Programmable Gate Array (FPGA), or an Application Specific Integrated Circuit (ASIC).

The storage device 12 comprises at least one memory that store a program executed by the controller 11 and a variety of types of data used by the controller 11. The storage device 12 may be constituted of a known recording medium, such as a magnetic recording medium or a semiconductor recording medium, or may be constituted of a combination of more than one type of recording media. Any recording medium, such as a portable recording medium that is attachable to or detachable from the electronic musical instrument 10, or a cloud storage that is accessible by the controller 11 via a network 90, may be used as the storage device 12.

The communication device 13 communicates with, for example, a machine learning system 40 via the network 90 either by wire or wirelessly. For example, the communication device 13 communicates with a machine learning system 40 described later. Alternatively, an independent communication device (e.g., a smart phone and a tablet) may be connected to the electronic musical instrument 10 either by wire or wirelessly.

The input device 14 receives user instructions from the user. The input device 14 may be a keypad or a touch panel.

The playing device 15 includes keys 151 provided in the musical keyboard, with each key 151 corresponding to a different pitch. The playing device 15 receives playing input by the user. When the user plays keys 151, the playing device 15 receives playing inputs from the user via the playing device 15. The playing device 15 detects a playing intensity X, which is an intensity with which the user plays the playing device 15, particularly, an intensity of a depression of a key 151. One optical sensor is provided for one key 151 to detect its displacement. A displacement speed is calculated based on a detected temporal change in displacement of the key 151 for use as a playing intensity X for the key 151. The configuration of the playing device 15 can be freely selected and is not limited to a musical keyboard. The key 151 is an example of an operator that is played by the user in playing of a piece of music on the musical instrument.

The sound source device 16 generates a sound signal V based on playing of the playing device 15. The sound signal V is a sample time series representative of a waveform of a musical sound produced by playing the playing device 15. Specifically, the sound signal V represents a pitched musical sound, and each pitch corresponds to a depressed key 151 of the playing device 15. The functions of the sound source device 16 may be implemented by the controller 11 that executes a program stored in the storage device 12. In this case, the sound source device 16 for generation use of the sound signal V may be omitted.

The sound emitting device 17 outputs musical sound represented by the sound signal V. Examples of the sound emitting device 17 include a speaker and a headphone set. Thus, in the first embodiment, the sound source device 16 and the sound emitting device 17 act as a playback system 18 that plays back musical sound based on playing by the user.

FIG. 2 is a block diagram showing a functional configuration of the electronic musical instrument 10. The controller 11 of the electronic musical instrument 10 acts as a characteristic setting section 30 and a playback controller 34 by executing a program stored in the storage device 12.

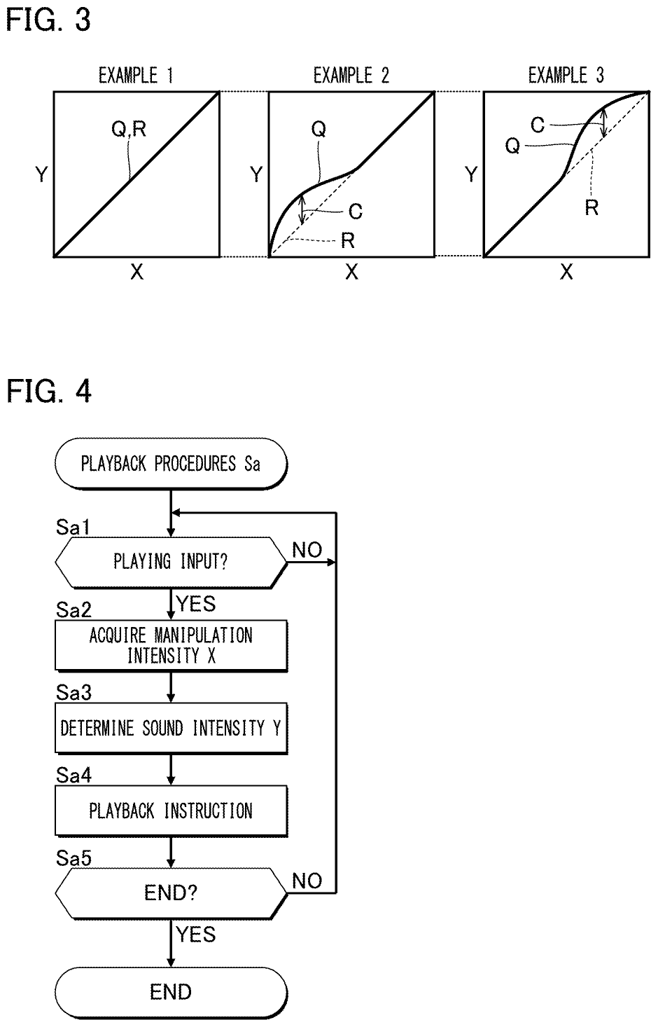

The characteristic setting section 30 sets an intensity characteristic Q. As shown in FIG. 3, the intensity characteristic Q constitutes a relationship between (i) a playing intensity X in playing the playing device 15 and (ii) a sound intensity Y, which is an intensity (e.g., a volume) of a musical sound output (played back) by the playback system 18 in response to playing of the electronic musical instrument 10 by the user. The intensity characteristic Q is depicted by a touch curve (or velocity curve) representative of a relationship between the playing intensity X and the sound intensity Y. Generally, the relationship defined by the intensity characteristic Q is such that the greater the playing intensity X, the greater the sound intensity Y. The intensity characteristic Q set by the characteristic setting section 30 is stored in the storage device 12.

The playback controller 34 shown in FIG. 2 controls playback of musical sound by the playback system 18. Specifically, the playback controller 34 outputs a playback instruction E to the playback system 18 (the sound source device 16) in response to playing of the playing device 15. The playback instruction E is event data that includes a pitch N and a sound intensity Y. The pitch N is represented by a pitch number that corresponds to a depressed key 151. The sound intensity Y is set to a numerical value depending on the playing intensity X under the relationship defined by the intensity characteristic Q. Thus, the playback controller 34 controls playback of the musical sound by the playback system 18 by using the intensity characteristic Q set by the characteristic setting section 30. The playback controller 34 controls the playback system 18 such that the musical sound produced by playing the playing device 15 is played back using the intensity characteristic Q.

FIG. 4 is a flow chart showing a playback procedures Sa for control of playback of the musical sound by the controller 11. The playback procedures Sa are started in response to a user instruction provided via the input device 14.

Upon start of the playback procedures Sa, the playback controller 34 waits for the user to play the playing device 15 (Sa1: NO). When the user plays the playing device 15 (Sa1: YES), the playback controller 34 acquires a playing intensity X of a depressed key 151 from the playing device 15 (Sa2). The playback controller 34 determines a sound intensity Y that corresponds to a current playing intensity X based on the intensity characteristic Q (Sa3). Next, the playback controller 34 transmits, to the sound source device 16, a playback instruction E that includes (i) a pitch N that corresponds to the depressed key 151 and (ii) a sound intensity Y that corresponds to the playing intensity X (Sa4). The foregoing procedures are repeated (Sa5: NO) until a user instruction to end the playback is received from the input device 14. When the user instruction is received (Sa5: YES), the playback procedures Sa are ended.

In the first embodiment, the characteristic setting section 30 sets an intensity characteristic Q based on a playing habit particular to the user. The intensity characteristic Q is set for each user. Before the intensity characteristic Q is set, a reference music piece, which is a predetermined piece of music, is played by the user on the playing device 15. The playing of the reference music piece is analyzed to identify the user's playing habit. The reference music piece is a piece of known music. To set the intensity characteristic Q, the characteristic setting section 30 generates correction data C from input data D that depends on the user's playing habit. Based on the generated correction data C, the characteristic setting section 30 corrects the initial intensity characteristic R (hereinafter, simply, “initial characteristic R”). The initial characteristic R is provided in advance. As shown in FIG. 3, the initial characteristic R has a proportional relationship (i.e., Y=X) between the playing intensity X and the sound intensity Y, which is stored in the storage device 12 in advance. As shown in FIG. 2, in the first embodiment, the characteristic setting section 30 includes an acquirer 31, a generator 32, and a corrector 33.

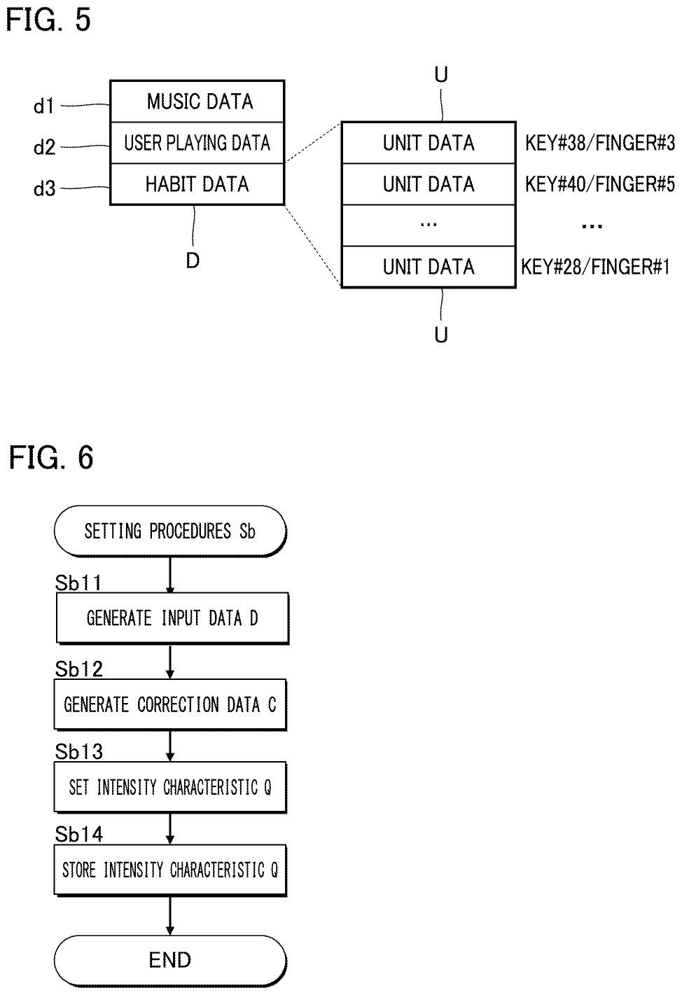

The acquirer 31 acquires input data D. FIG. 5 is a schematic diagram showing the input data D. In the first embodiment, the input data D includes music data d1, user playing data d2, and habit data d3. The music data d1 is time series data that conforms to the Musical Instrument Digital Interface (MIDI) Standard, and represents a part of, or all of music scores of the reference music piece. Specifically, the music data d1 represents (i) a pitch of each of the notes of the reference music piece, (ii) a duration of the note, (iii) an intensity of the note, and (iv) a finger number of the note. The finger number indicates a finger (thumb, index, middle, ring or little finger of the left or right hand) to be used to depress the key. For each note, a finger number is indicated. The user playing data d2 is time series data that conforms to the MIDI Standard, and represents actual playing of the reference music piece by the user. Specifically, the user playing data d2 represents a time series of notes played by the user with the playing device 15, each note having a pitch and a duration (sounding period). A duration (sounding period) of each of the notes in the music data d1 and the user playing data d2 may be defined by a combination of a start point and an end point, or may be defined by a combination of the start point and a duration. The music data d1 is indicative of exemplary playing of the reference music piece (model playing), and the user playing data d2 is indicative of actual playing by the user.

The habit data d3 indicates the user's playing habits in playing the reference music piece. Specifically, the habit data d3 indicates playing characteristics, each of which corresponds to a characteristic of the user in playing a key 151 while playing the reference music piece. Specifically, the habit data d3 is includes pieces of unit data U, each of which is constituted of a combination of a key 151 and a finger number (for a user's finger) that is used to play the key 151. A piece of unit data U represents a playing characteristic of the user in playing a key 151 with a finger. As described above, in the music data d1, a finger number is indicated for each of the notes of the reference music piece. A piece of unit data U indicative of a playing characteristic is generated for each combination of (i) a key 151 for a corresponding note of the reference music piece and (ii) a finger number indicated by the music data d1 for the key 151.

The playing characteristic indicated by unit data U includes a playing intensity X of a note of the reference music piece played by the user, and an error τ of a duration of a note. The error τ represents a difference between (i) an exemplary duration of the note indicated by the music data d1 and (ii) an actual duration of the note played by the user. For example, the error τ represents a timing error at a start point or at an end point of the note, or an error in a duration of the note.

If the user is poor at playing a specific key 151 with a specific finger, the playing intensity X included in unit data U for the combination of the key 151 and the finger tends to be smaller than the sound intensity indicated by the music data d1. Alternatively, if the user is poor at depressing a specific key 151 with a specific finger (i.e., the key is not depressed sufficiently over the duration of the note), the error τ tends to be greater. Thus, the habit data d3 indicates the user's playing habits. That is, the habit data d3 indicates a level of playing technique of the user (a degree of skill in playing).

As shown in FIG. 2, the generator 32 generates correction data C based on the input data D acquired by the acquirer 31. Specifically, the correction data C is used to correct the initial characteristic R. The correction data C is set such that playing of a piece of music by the user is assisted by use of the intensity characteristic Q.

If the playing intensity X is lacking due to a tendency of the user to depress a key 151 too softly (slowly), as shown in Example 2 of FIG. 3, the correction data C is generated for a low value (low range) of the playing intensity X (the horizontal axis), to increase the sound intensity Y (the vertical axis) from the initial characteristic R. In contrast, if the playing intensity X is lacking due to a tendency of the user to depress the key 151 too hard (quickly), as shown in Example 3 of FIG. 3, the correction data C is generated for a high value (high range) of the playing intensity X, to increase the sound intensity Y from the initial characteristic R. Alternatively, if there is no tendency by the player to depress the key 151 either too softly (slowly) or too hard (quickly) and thus the playing intensity X is not lacking, as shown in Example 1 of FIG. 3, the correction data C is generated to maintain the intensity characteristic Q at the same level as the initial characteristic R. Thus, the correction data C is applied to the initial characteristic R to specify a correction value (correction amount) of the sound intensity Y at each of a point of the playing intensity X. Each correction value may be added to a value of the initial characteristic R corresponding to a point of the playing intensity X (the horizontal axis), or may be subtracted from a numerical value of the initial characteristic R corresponding to a point of the playing intensity X.

The trained model M is used to generate the correction data C. Actual playing of the reference music piece by the user (i.e., user playing data d2) and user's playing habits (i.e., habit data d3) correlate with an intensity characteristic Q (or the correction data C), which assists playing of a piece of music by the user. The trained model M is a statistical estimation model that learns the correlation. Specifically, the trained model M learns a relationship between (i) the reference music piece and a playing habits (i.e., input data D), and (ii) correction to the initial characteristic R (i.e., correction data C), by machine learning. The generator 32 inputs the input data D into the trained model M, as a result of which correction data C is output from the trained model M.

The trained model M is a deep neural network (DNN), for example. A type of the deep neural network can be freely selected. For example, a Recursive Neural Network (RNN) or a Convolutional Neural Network (CNN) is used as the trained model M. The trained model M may comprises a combination of multiple deep neural networks. Additional elements, such as Long Short-Term Memory (LSTM) can be provided in the trained model M.

The trained model M is implemented by a combination of a program executed by the controller 11 to generate correction data C using the input data D, and variables (e.g., weights and biases) used to generate the correction data C. The program for the trained model M and the variables are stored in the storage device 12. Numerical values of the variables of the trained model M are set in advance by machine learning.

As shown in FIG. 2, the corrector 33 corrects the initial characteristic R with the correction data C generated by the generator 32, to set an intensity characteristic Q. Specifically, the corrector 33 reads the initial characteristic R stored in the storage device 12 and applies the correction data C to the initial characteristic R, to generate the intensity characteristic Q. Specifically, the corrector 33 adds a correction value, which is indicated by the correction data C, to the sound intensity Y at any point of the playing intensity X to correct the initial characteristic R. Alternatively, the corrector 33 may subtract a correction value from the sound intensity Y at any point of the playing intensity X. The initial characteristic R is an example of a “first intensity characteristic,” and the intensity characteristic Q is an example of a “second intensity characteristic.”

FIG. 6 is a flow chart showing an example of setting procedures Sb to set an intensity characteristic Q. The setting procedures Sb are started in response to a user instruction provided to the input device 14. Upon start of the setting procedures Sb, the user plays the reference music piece with the playing device 15.

The acquirer 31 generates input data D by analyzing the user's playing of the reference music piece (Sb11). The generator 32 inputs the input data D to the trained model M, to generate correction data C (Sb12). The corrector 33 corrects the initial characteristic R, which is stored in the storage device 12, with the correction data C to set the intensity characteristic Q (Sb13). The corrector 33 stores the intensity characteristic Q in the storage device 12 (Sb14).

In the first embodiment, the initial characteristic R is corrected by the correction data C output from the trained model M, thereby setting the intensity characteristic Q that shows user's playing habits in playing the electronic musical instrument. For example, it is possible to set an intensity characteristic Q to assist playing of a piece of music at which the user is poor.

In the first embodiment, in particular, the habit data d3 indicates a playing characteristic of each of the keys 151 (the playing intensity X and the error T). As a result, the intensity characteristic Q that reflects the user's playing habits for the keys 151 can be set. More specifically, the habit data d3 indicates the user's playing characteristics, each of which shows a combination of a key 151 and a user's finger. As a result, an appropriate intensity characteristic Q can be generated, which shows the user's playing habit for a key 151 (e.g., poor at depressing a specific key 151 with a specific finger). Further, in the first embodiment, since the input data D includes the user playing data d2, an intensity characteristic Q that shows user's playing habit can be generated.

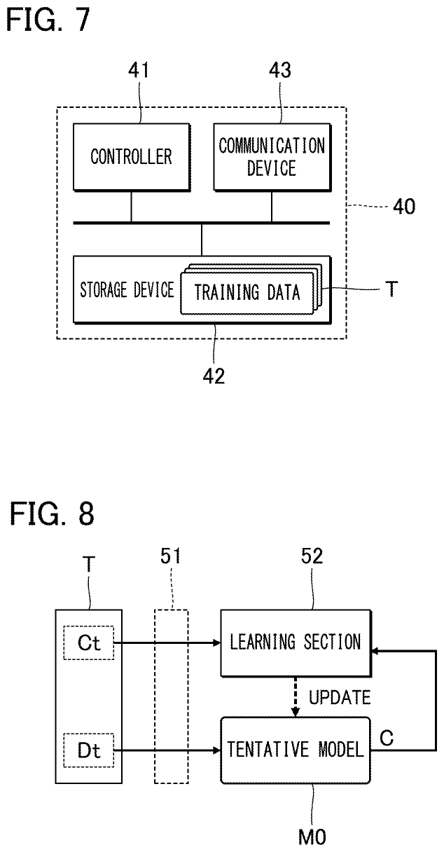

The machine learning system 40 shown in FIG. 1 generates the foregoing trained model M. FIG. 7 is a block diagram showing an example of a configuration of the machine learning system 40. The machine learning system 40 includes a controller 41, a storage device 42, and a communication device 43. The machine learning system 40 may be implemented not only as a single device, but also as more than one independent device.

The controller 41 includes one or more processors that control each element of the machine learning system 40. The controller 41 is constituted of one or more processors, such as a CPU, a SPU, a DSP, a FPGA, or an ASIC. The communication device 43 communicates with the electronic musical instrument 10 via the network 90.

The storage device 42 comprises at least one memory that stores a program executed by the controller 41 and a variety of types of data used by the controller 41. The storage device 42 may be constituted of a known recording medium, such as a magnetic recording medium or a semiconductor recording medium, or it may be constituted of a combination of more than one type of recording media. Any recording medium, such as a portable recording medium that is attachable to or detachable from the machine learning system 40, or a cloud storage that is accessible by the controller 41 via the network 90, may be used as the storage device 42.

FIG. 8 is a block diagram showing an example of a functional configuration of the machine learning system 40. The controller 41 executes the program stored in the storage device 42 to implement elements (an acquirer 51 and a learning section 52) that establish the trained model M by machine learning.

The learning section 52 establishes a trained model M by supervised machine learning using pieces of training data T. The acquirer 51 acquires the pieces of training data T from the storage device 42.

Each of the pieces of training data T includes training input data Dt and training correction data Ct. The training input data Dt is generated from playing of the reference music piece by a large number of users. The training correction data Ct included in each of the pieces of training data T is generated in advance by a person who creates the training data T. The training correction data Ct represents a difference between (i) an intensity characteristic Q appropriate for a playing habit indicated by the training input data Dt, and (ii) the initial characteristic R. That is, the training correction data Ct is used to set the intensity characteristic Q appropriate for a playing habit indicated by the training input data Dt included in the training data T, and corresponds to a ground truth (label) to be output by the trained model M for the training input data Dt.

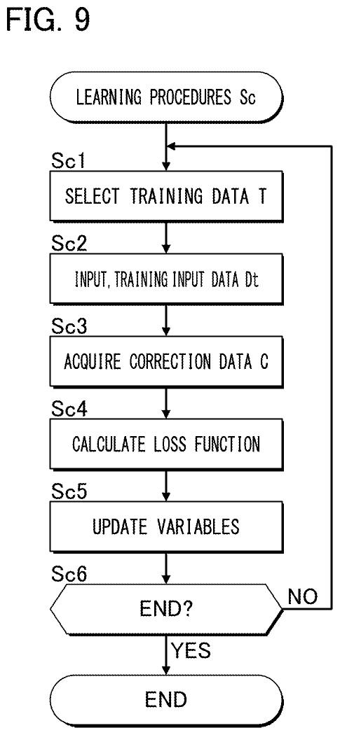

FIG. 9 is a flow chart showing an example of learning procedures Sc to establish the trained model M by machine learning. The learning procedures Sc are expressed by a method for generating a trained model M.

When the learning procedures Sc are started, the acquirer 51 selects training data T from among the pieces of training data T stored in the storage device 42 (Sc1). As shown in FIG. 8, the learning section 52 inputs, into an initial or tentative model M0 (hereinafter, “tentative model M0”), training input data Dt included in the selected training data T (Sc2). When the tentative model M0 outputs correction data C in response to the input, the learning section 52 acquires the correction data C from the tentative model M0 (Sc3).

The learning section 52 calculates a loss function representative of an error between the correction data C generated by the tentative model M0 and the training correction data Ct included in the selected training data T (Sc4). The learning section 52 updates variables of the tentative model M0 such that the loss function is reduced (ideally, minimized) (Sc5). For example, an error back propagation method is used to update the variables of the loss function.

The learning section 52 determines whether a termination condition is satisfied (Sc6). The termination condition may be defined by the loss function below a threshold, or may be defined by an amount of change in the loss function below a threshold. When the termination condition is not satisfied (Sc6: NO), the acquirer 51 selects new training data T that has not yet been selected (Sc1). Thus, until the termination condition is satisfied (Sc6: YES), updating of the variables of the tentative model M0 is repeated (Sc1-Sc5). When the termination condition is satisfied (Sc6: YES), the learning section 52 terminates the learning procedures Sc. The tentative model M0 given at the time at which the termination condition is satisfied is determined as the trained model M. Variables of the trained model M are fixed to numerical values given at the end of the learning procedures Sc.

Under a potential relationship between training input data Dt and training correction data Ct included in each piece of training data T, the trained model M outputs statistically reasonable correction data C for unknown input data D. Thus, the trained model M is a statistical training model that learns a relationship between (i) the reference music piece and a playing habit (i.e., input data D), and (ii) correction to the initial characteristics R (i.e., correction data C), by machine learning.

The learning section 52 transmits the trained model M established by the learning procedures Sc (specifically, the variables thereof) to the electronic musical instrument 10 via the communication device 43. Upon receipt of the trained model M from the machine learning system 40, the controller 11 of the electronic musical instrument 10 stores the received trained model M (specifically, the variables thereof) in the storage device 12.

### B: Second Embodiment

The second embodiment will now be described. In the embodiments described below, like reference signs are used for elements that have functions or effects that are the same as those of elements described in the first embodiment, and detailed explanation of such elements is omitted as appropriate.

In the first embodiment, the learning procedures Sc are executed by the controller 41 of the machine learning system 40. In contrast, in the second embodiment, the learning procedures Sc are executed by the controller 11 of the electronic musical instrument 10 to establish the trained model M. The controller 11 acts as the acquirer 51 and the learning section 52 shown in FIG. 8. The acquirer 51 acquires pieces of training data T from the storage device 12. The learning section 52 establishes a trained model M by supervised machine learning using the acquired pieces of training data T.

In a similar manner as for the learning procedures Sc according to the first embodiment, the controller 11 of the electronic musical instrument 10 establishes a trained model M using the pieces of training data T stored in the storage device 12. In addition to new establishment of the trained model M, the controller 11 updates the trained model M using new training data T that indicates user's playing of the electronic musical instrument 10. Thus, pieces of new training data T are collected by continuous use of the electronic musical instrument 10, and the trained model M is re-trained by the learning procedures Sc.

The acquirer 51 acquires (generates) training input data Dt included in the new training data T by analyzing the user's playing of the playing device 15. Further, the acquirer 51 acquires training correction data Ct for the new training data T by analyzing the user's playing of the playing device 15. Specifically, for each playing habit of the reference music piece, a piece of correction data C is acquired in advance. The acquirer 51 selects, as training correction data Ct (i.e., ground truth) for new training data T, correction data C that corresponds to a playing habit of the user from among the provided pieces of correction data C. The acquirer 51 stores, in the storage device 12, the new training data T that includes the training input data Dt and training correction data Ct. A difference between the intensity characteristic Q indicated by the user with the input device 14 and the initial characteristic R may be used as the training correction data Ct.

When a sufficient number of pieces of new training data T, which exceeds a threshold value, are stored in the storage device 12, the controller 11 of the electronic musical instrument 10 executes the learning procedures Sc using the pieces of new training data T. Specifically, the controller 11 uses the current trained model M as the tentative model M0 shown in FIG. 8, and executes the learning procedures Sc described in the first embodiment to update the variables of the tentative model M0. Thus, the procedures to select the new training data T (Sc1) and the procedures to update the variables of the tentative model M0 (Sc2 to Sc5) are repeated.

The second embodiment provides the same effects as those of the first embodiment. Further, in the second embodiment, the variables of the trained model M are updated using the new training data T that indicates the user's playing habits (i.e., the trained model M is re-trained). As a result, a trained model M appropriate for the user's playing habit can be established.

### C: Third Embodiment

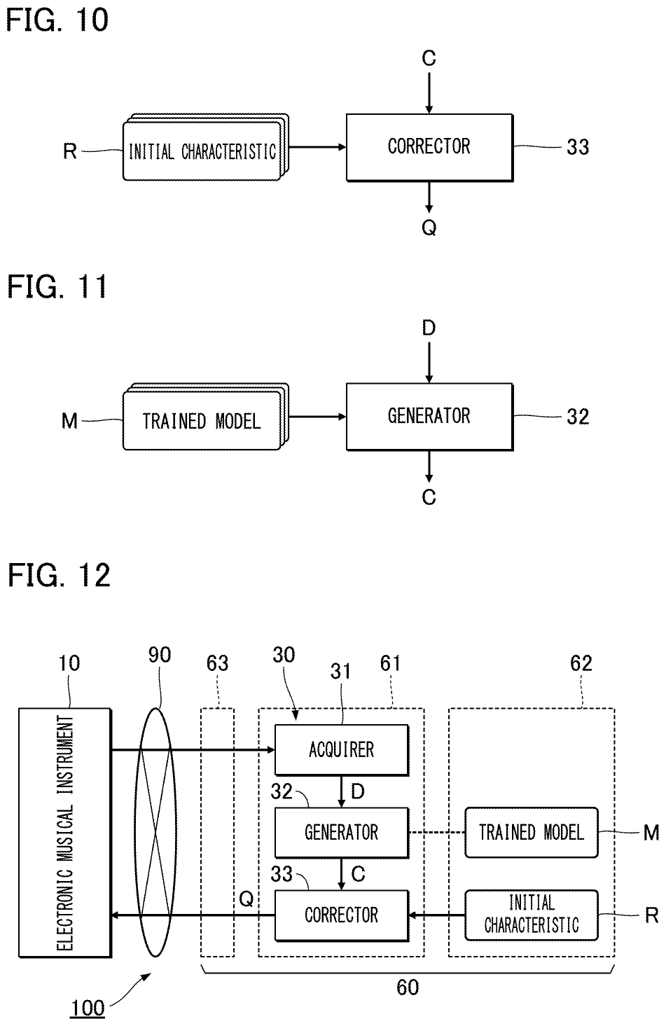

FIG. 10 is an explanatory diagram showing a corrector 33 according to the third embodiment. In the third embodiment, multiple initial characteristics R are stored in the storage device 12. The relationship between the playing intensity X and the sound intensity Y differs for each initial characteristic R.

In the third embodiment, the sound source device 16 generates a sound signal V representative of a playing sound with a tone. Specifically, the sound signal V represents a playing sound with a tone selected by the user via the input device 14 from among multiple types of tones. Initial characteristics R, each corresponding to a different tone generated by the sound source device 16, are stored in the storage device 12. An initial characteristic R that corresponds to a tone refers to an intensity characteristic appropriate for the tone (a relationship between the playing intensity X and the sound intensity Y).

In the third embodiment, the corrector 33 corrects an initial characteristic R from among the multiple initial characteristics R with the correction data C, to set the intensity characteristic Q. Specifically, in the setting procedures Sb, the corrector 33 selects an initial characteristic R that corresponds to the selected tone, and corrects the selected initial characteristic R with the correction data C to generate the intensity characteristic Q (Sb13). The intensity characteristic Q set by such steps is applied to the determination (Sa3) of the sound intensity Yin the playback procedures Sa.

The third embodiment provides the same effects as those of the first embodiment. Further, in the third embodiment, the intensity characteristic Q is set based on the correction of the initial characteristic R that correspond to the selected tone from among the multiple initial characteristics R. As a result, an intensity characteristic Q appropriate for the tone selected by the user can be set. The third embodiment is also applied to the second embodiment.

In the foregoing description, multiple characteristics R are used selectively, but musical elements that distinguish the initial characteristics R are not limited to tones. An appropriate intensity characteristic Q tends to differ for each music genre played by the user. In view of such a tendency, multiple initial characteristics R, each corresponding to a different music genre, may be stored in the storage device 12.

An initial characteristic R that corresponds to a music genre refers to an intensity characteristic appropriate for playing in the music genre (a relationship between the playing intensity X and the sound intensity Y). The corrector 33 selects an initial characteristic R that corresponds to the music genre selected by the user from among the multiple initial characteristics R, and corrects the selected initial characteristic R with the correction data C to set the intensity characteristic Q. In this way, an intensity characteristic Q appropriate for the music genre is played by the user.

### D: Fourth Embodiment

FIG. 11 is an explanatory diagram showing a generator 32 according to the fourth embodiment. In the fourth embodiment, the sound source device 16 generates a sound signal V representative of the selected tone from among the multiple types of tones in a similar manner to the third embodiment. Multiple trained models M, each corresponding to a different tone that is generated by the sound source device 16, are stored in the storage device 12. In the learning procedures Sc, a trained model M that corresponds to a tone is established, in which training data T that includes training input data Dt is used. The training input data Dt indicates playing of the reference music piece with the tone, and is obtained by playing by large number of players. A trained model M that corresponds to a tone corrects the initial characteristic R to the intensity characteristic Q appropriate for the tone.

In the fourth embodiment, the generator 32 generates correction data C using any of the multiple trained models M. Specifically, in the setting procedures Sb, the generator 32 inputs the input data D to the selected trained model M that corresponds to the selected tone. As a result, correction data C is output from the trained model M (Sb12). The correction data C set in the foregoing steps is applied to the intensity characteristic Q (Sb13).

The fourth embodiment provides the same effects as those of the first embodiment. Further, in the fourth embodiment, a trained model M that corresponds to the selected tone from among the multiple trained models M is used to generate the correction data C. As a result, an intensity characteristic Q appropriate for the tone selected by the user can be set as in the third embodiment. The fourth embodiment is also applied to the second or the third embodiment.

In the foregoing description, any of the multiple trained models M is used, but musical elements that distinguish each trained model M are not limited to the tones. An appropriate intensity characteristic Q tends to differ for each music genre. In view of such a tendency, multiple trained models M, each corresponding to a different music genre, may be stored in the storage device 12.

A trained model M that corresponds to a music genre is used to generate correction data C appropriate for the music genre. Specifically, the generator 32 selects a trained model M that corresponds to the music genre selected by the user from among the multiple trained models M, and inputs input data D to the selected trained model M to generate the correction data C. According to this aspect, the intensity characteristic Q appropriate for the music genre played by the user can be set.

### E: Fifth Embodiment

FIG. 12 is a block diagram showing an example of a configuration of a performance system 100 according to the fifth embodiment. The performance system 100 includes an electronic musical instrument 10 and a control system 60. The control system 60 is implemented by a computer system, and includes a controller 61, a storage device 62, and a communication device 63.

The controller 61 comprises one or more processors that control components of the control system 60. Specifically, the controller 61 is constituted of one or more processors, such as a CPU, a SPU, a DSP, a FPGA, or an ASIC. The communication device 63 communicates with the electronic musical instrument 10 via the network 90.

The storage device 62 comprises at least one memory that stores a program executed by the controller 61 and a variety of types of data used by the controller 61. The storage device 62 may be constituted of a known recording medium, such as a magnetic recording medium or a semiconductor recording medium, or may be constituted of a combination of more than one type of recording media. Any recording medium, such as a portable recording medium that is attachable to or detachable from the control system 60, or a cloud storage that is accessible by the controller 61 via the network 90, may be used as the storage device 62.

The controller 61 executes a program stored in the storage device 62 to implement the characteristic setting section 30 described in the first embodiment. The characteristic setting section 30 includes an acquirer 31, a generator 32, and a corrector 33. The acquirer 31 acquires input data D generated by the electronic musical instrument 10 via the communication device 63. As in the first embodiment, the generator 32 inputs the input data D into the trained model M, to output correction data C. The corrector 33 corrects the initial characteristic R with the correction data C to set the intensity characteristic Q. The intensity characteristic Q is transmitted to the electronic musical instrument 10 via the communication device 63. The trained model M and the initial characteristic R are stored in the storage device 62. Specifically, the trained model M established by the machine learning system 40 is transferred to the control system 60, and the trained model M is stored in the storage device 62.

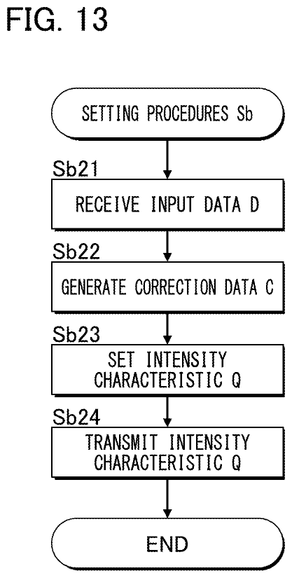

FIG. 13 is a flow chart showing setting procedures Sb executed by the controller 61 of the control system 60. When the setting procedures Sb are started, the acquirer 31 receives input data D from the electronic musical instrument 10 via the communication device 63 (Sb21). The following are examples of acquisition of input data D: the generation of the input data D by the acquirer 31 according to the first embodiment (Sb11), and the receipt of the input data D by the acquirer 31 according to the fifth embodiment (Sb21).

In a manner similar to the first embodiment, the generator 32 inputs the input data D into the trained model M, to generate correction data C (Sb22). The corrector 33 corrects the initial characteristic R stored in the storage device 62 with the correction data C, to set the intensity characteristic Q (Sb23). The corrector 33 transmits the intensity characteristic Q to the electronic musical instrument 10 via the communication device 63 (Sb24). The communication device 13 of the electronic musical instrument 10 receives the intensity characteristic Q from the control system 60. The controller 11 of the electronic musical instrument 10 acts as a playback controller 34, which controls, using the received intensity characteristic Q, playback of a piece of music by the playback system 18.

As will be apparent from the above description, the fifth embodiment provides the same effects as those of the first embodiment. The configurations of the second to fourth embodiments may also be applied to the fifth embodiment in which the setting procedures Sb are executed by the control system 60. Specifically, as in the third embodiment, the corrector 33 of the control system 60 may correct any of multiple initial characteristics R with the correction data C. Alternatively, as in the fourth embodiment, the generator 32 of the control system may generate the correction data C using any of the multiple trained models M.

### F: Sixth Embodiment

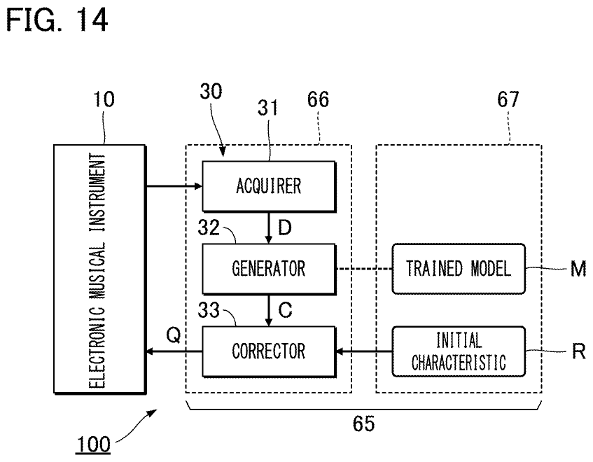

FIG. 14 is a block diagram showing an example of a configuration of the performance system 100 according to the sixth embodiment. In the sixth embodiment the performance system 100 includes an electronic musical instrument 10 and a computing device 65. Examples of the computing device 65 include a smartphone and a tablet. The computing device 65 is connected to the electronic musical instrument 10 either by wire or wirelessly.

The computing device 65 includes a controller 66 and a storage device 67. The controller 66 comprises one or more processors that control components of the computing device 65. Specifically, the controller 66 is constituted of one or more processors, such as a CPU, SPU, DSP, FPGA or a ASIC. The storage device 67 comprises at least one memory that stores a program executed by the controller 66 and a variety of types of data used by the controller 66. The storage device 67 may be constituted of a known recording medium, such as a magnetic recording medium or a semiconductor recording medium, or it may be constituted of a combination of more than one type of recording media. Any recording medium, such as a portable recording medium that is attachable to or detachable from the computing device 65, or a cloud storage that is accessible by the controller 66 via the network 90, may be used as the storage device 67.

The controller 66 executes a program stored in the storage device 67 to implement the characteristic setting section 30 described in the first embodiment. The characteristic setting section 30 executes the setting procedures Sb described in the first embodiment, and includes an acquirer 31, a generator 32, and a corrector 33. The acquirer 31 receives input data D generated by the electronic musical instrument 10. As in the first embodiment, the generator 32 outputs the correction data C by inputting the input data D into the trained model M. The corrector 33 corrects the initial characteristic R with the correction data C, to set the intensity characteristic Q. The intensity characteristic Q is transmitted to the electronic musical instrument 10. The trained model M and the initial characteristic R are stored in the storage device 67. Specifically, the trained model M established by the machine learning system 40 is transferred to the computing device 65, and the trained model M is stored in the storage device 67.

The sixth embodiment provides the same effects as those of the first embodiment. The configurations of the second to fourth embodiments are also applied to the sixth embodiment in which the setting procedures Sb are executed by the computing device 65.

### G: Seventh Embodiment

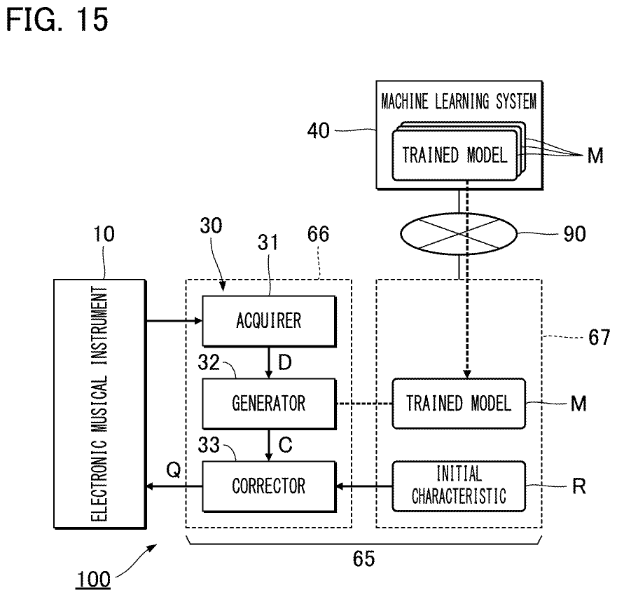

FIG. 15 is a block diagram showing an example of a configuration of a performance system 100 according to the seventh embodiment. As in the sixth embodiment, the performance system 100 includes an electronic musical instrument 10 and a computing device 65. The configurations of the electronic musical instrument 10 and the computing device 65 are the same as those of the sixth embodiment.

Multiple trained models M, each corresponding to a different type of the electronic musical instrument 10, are stored in the machine learning system 40. The relationship between the input data D and the correction data C, which is learned by the trained model M in learning procedures Sc, differs for each trained model M (i.e., for each type of the electronic musical instrument 10). Specifically, pieces of training data T are provided for each type of the electronic musical instrument 10. In the learning procedures Sc, the trained model M for a corresponding type of the electronic musical instrument 10 is established using the pieces of training data T for that type. As a result, even when the same input data D is input into each trained model M, different correction data C is output from each trained model M. That is, the intensity characteristic Q corrected by the corrector 33 differs for each type of the electronic musical instrument 10.

The computing device 65 acquires any of the multiple trained models M included in the machine learning system 40 via the network 90. Specifically, from the machine learning system 40, the computing device 65 acquires a trained model M that corresponds to the type of the electronic musical instrument 10 connected to the computing device 65 from among the multiple trained models M. The acquired trained model M is stored in the storage device 67, and is used in the setting procedures Sb. The setting procedures Sb are the same as those of the foregoing embodiments.

Thus, the seventh embodiment provides the same effects as those of the sixth embodiment. Further, in the seventh embodiment, a trained model M is established for each type of the electronic musical instrument 10. As a result, the correction data C (also the intensity characteristic Q) appropriate for each type of the electronic musical instrument 10 can be generated with high accuracy, as compared with a case in which the same trained model M is used regardless of the type of the electronic musical instrument 10.

The configurations of the second to fourth embodiments are also applied to the seventh embodiment in which the setting procedures Sb are executed by the computing device 65. The following are examples of an “information processing system:” the electronic musical instrument 10 according to the first through fourth embodiments, the control system 60 according to the fifth embodiment, and the computing device 65 according to the sixth and seventh embodiments.

In the first through fourth embodiments, as in the seventh embodiment, a trained model M that corresponds to the type of the electronic musical instrument 10 may be transmitted from the machine learning system 40 to the electronic musical instrument 10. Alternatively, in the fifth embodiment, as in the seventh embodiment, such a trained model M may be transmitted from the machine learning system 40 to the control system 60. The initial characteristic R applied to the setting procedures Sb may be provided for each type of the electronic musical instrument 10.

### H: Eighth Embodiment

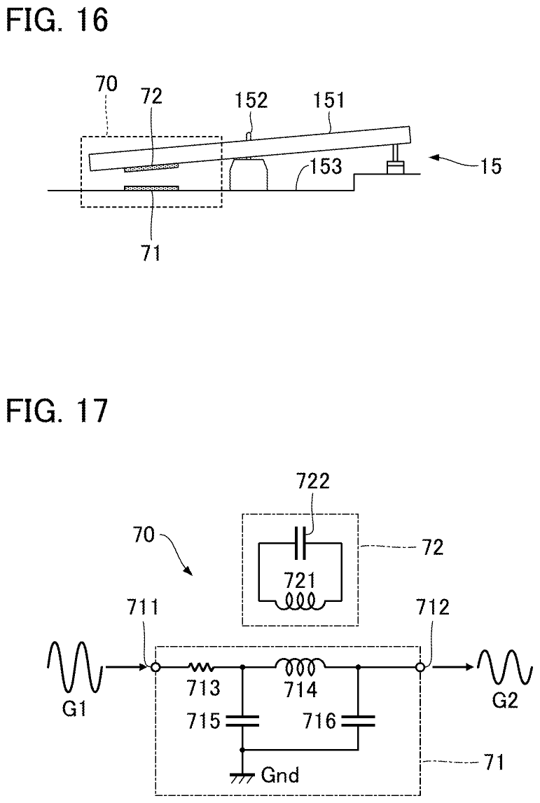

FIG. 16 is a side view of a key 151 of the musical keyboard (playing device 15). The key 151 is supported on a support member 153 via a fulcrum 152. The end of the key 151 is displaced vertically by pressing and releasing the key. The playing device 15 includes detectors 70, each corresponding to a different key 151. A detector 70 for the key 151 is a sensor that generates a detection signal depending on the displacement of the key 151. The detector 70 includes a signal generator 71 and a detectable portion 72. The signal generator 71 is disposed on the support member 153, and the detectable portion 72 is disposed on the key 151.

FIG. 17 is a circuit diagram showing an example of a configuration of a detector 70. The signal generator 71 of the detector 70 is a resonant circuit that includes an input terminal 711, an output terminal 712, a resistor 713, a coil 714, and capacitors 715 and 716. One end of the resistor 713 is connected to the input terminal 711, and the other end of the resistor 713 is connected to one end of the capacitor 715 and to one end of the coil 714. The other end of the coil 714 is connected to the output terminal 712 and to one end of the capacitor 716. The other end of the capacitor 715 and the other end of the capacitor 716 are each grounded (GND).

The detectable portion 72 of each detector 70 is a resonance circuit that includes a coil 721 and a capacitor 722. One end of the coil 721 is connected to one end of the capacitor 722, and the other end of the coil 721 is connected to the other end of the capacitor 722. The resonance frequency of the signal generator 71 is set to be substantially the same frequency as that of the detectable portion 72.

The input terminal 711 of the signal generator 71 receives a reference signal G1 in time division. The reference signal G1 is a periodic signal that varies at a frequency equivalent to the resonant frequencies of the signal generator 71 and the detectable portion 72. Supply of the reference signal G1 to the coil 714 via the resistor 713 produces a magnetic field in the coil 714. The magnetic field causes a current to be induced in the coil 721 of the detectable portion 72 via electromagnetic induction. Thus, a magnetic field is generated in the coil 721 in a direction that cancels a change in the magnetic field in the coil 714. The magnetic field generated in the coil 721 changes depending on the distance between the coils 714 and 721. As a result, a detection signal G2 with a level that depends on a distance between the coils 714 and 721 is output from the output terminal 712 of the signal generator 71.

The acquirer 31 calculates a displacement of the key 151, one after another, by analyzing a detection signal G2 supplied from the signal generator 71 of the key 151. The controller 11 or 61 calculates a playing intensity X from a temporal change of the displacement calculated from the detection signal G2. In the eighth embodiment, the user playing data d2 indicates a time series of displacements, each of which is calculated for the key 151 from the detection signal G2. Thus, the user playing data d2 represents a temporal continuous or stepwise change in the displacement of the key 151.

The eighth embodiment provides the same effects as those of the first embodiment. The configurations of the second to seventh embodiments are also applied to the eighth embodiment.

### I: Modifications

Specific modifications applicable to each of the aspects described above are set out below. More than one mode selected from the following descriptions may be combined, as appropriate, as long as such combination does not give rise to any conflict.

(1) In the foregoing embodiments, playing characteristics indicated by habit data d3 are exemplified as the error τ in the playing intensity X and the duration of a note. However, the playing characteristics indicated by the habit data d3 are not limited to such examples.

A playing characteristic indicated by the habit data d3 may be an initial touch, which is a playing intensity X at a time at which the key 151 is touched by the user to depress the key. Alternatively, the playing characteristic may be an after touch, which is a playing intensity X with which the key 151 is pressed after being depressed. A playing characteristic indicated by the habit data d3 may be a tempo at which a user plays a piece of music, or may be a dynamic, such as piano or forte.

(2) In the foregoing embodiments, the input data D includes the music data d1, the user playing data d2, and the habit data d3. However, the input data D is not limited thereto.

The music data d1 or the user playing data d2 may be omitted, and the input data D may include video images that show how the user plays the electronic musical instrument (how the user's hands move on the musical keyboard).

(3) A method for correcting the initial characteristic R using the correction data C can be freely selected. In one example, correction values for points of the playing intensity X (the horizontal axis) are identified by the correction data C. To generate an intensity characteristic Q, the corrector 33 may calculate the initial characteristic R as follows: a weighted value, which is a variable and is set by the user via the input device 14, is multiplied by each of a correction value. The multiplied values are added to the sound intensity Y corresponding to points of the playing intensity X (the horizontal axis). Alternatively, the multiplied values may be subtracted from the sound intensity Y. In this example, a degree of correction made by the correction data C is changeable.

(4) In the foregoing embodiments, an example is given of a DNN as a trained model M; however the trained model M is not limited to such an example. For example, a Hidden Markov Model (HMM), Support Vector Machine (SVM) or other similar statistical estimation model may be used for the trained model M. A trained model M to which SVM is applied will now be described.

In one example, the trained model M comprises more than one SVM that corresponds to a combination of two types of correction data C (multi-class SVM). Specifically, one SVM is provided for each of the combination in which two types of the correction data C are selected from among different types of correction data C. Each SVM, which corresponds to a combination of two types of correction data C, determines a hyperplane in a multi-dimensional space by machine learning (learning procedures Sc). The hyperplane represents a boundary that separates data points into two classes in the multi-dimensional space, namely: a class that includes data points of the input data D that corresponds to one of the two types of correction data C, and a class that includes data points of the input data D that corresponds to the other of the two types of correction data C.

The generator 32 inputs input data D to each SVM included in the trained model M. Each SVM finds the input data D belongs between the two classes, and selects correction data C that corresponds to the found class between the two types of correction data C. The generator 32 selects correction data C in which the number of selections by the SVMs is the maximum from among different types of correction data C. Thus, regardless of the type of trained model M, the generator 32 outputs correction data C by inputting the input data D into the trained model M.

(5) In the foregoing embodiments, learning procedures Sc are described as one method for supervised machine training using pieces of training data T. However, the trained model M may be established by unsupervised machine learning without use of training data T, or by reinforcement learning that maximizes rewards. The unsupervised machine learning may be machine learning using known clustering.

(6) In the foregoing embodiments, the trained model M is established by the machine learning system 40. However, the functions of the machine learning system 40 (the acquirer 51 and the learning section 52) may be implemented by: the electronic musical instrument 10 according to the first through fourth embodiments, the control system 60 according to the fifth embodiment, or the computing device 65 according to the sixth and seventh embodiments.

(7) In the foregoing embodiments, a trained model M is used, which learns a relationship between the input data D and the correction data C. However, methods for generating the correction data C from the input data D are not limited to such an example. Specifically, a reference table (data table) can be provided in which each piece of input data D is associated with a corresponding piece of correction data C, and which is used to generate the correction data C by the generator 32. The reference table is stored in the storage device 12. The generator 32 searches the reference table for correction data C that corresponds to the input data D acquired by the acquirer 31.

(8) The functions described in the foregoing embodiments (e.g., the acquirer 31, the generator 32, and the corrector 33) are implemented by cooperation of one or more processors (e.g., 11, 61 and 65), which comprises the controller, and a programs stored in the storage device (e.g., 12, 62 and 67). The program may be provided by being pre-recorded on a computer-readable recording medium, and may be installed in a computer. For example, the computer-readable recording medium may be a non-transitory recording medium, examples of which include an optical recording medium (optical disk), such as a CD-ROM. The computer-readable recording medium may be a known recording medium, such as a semiconductor recording medium, or a magnetic recording medium. The non-transitory recording medium includes any recording medium excluding a transitory propagating signal. A volatile recording medium is not excluded. When programs are distributed by a distribution device via the network, a storage device included in the distribution device corresponds to a non-transient recording medium described above.

### J: Appendices

The following configurations are derivable from the foregoing embodiments.

An information processing system according to one aspect (aspect 1) includes: at least one memory that stores a program; and at least one processor that executes the program to: acquire input data that includes habit data indicative of a playing habit of a user in playing a musical instrument; generate correction data by inputting the acquired input data into at least one trained model that learns a relationship between training input data and training correction data; and correct, using the generated correction data, at least one first intensity characteristic representative of a relationship between: (i) a playing intensity in playing the musical instrument by the user; and (ii) a sound intensity of a musical sound output in response to playing of the musical instrument.

According to this aspect, an intensity characteristic showing a playing habit of the user in playing a musical instrument can be set by correcting the first intensity characteristic using the correction data output by the trained model. For example, it is possible to set an intensity characteristic Q, to assist a user in playing a piece of music for which the user is judged poor.

The phrase “playing intensity” refers to a playing intensity by the user, typical examples of which include an intensity with which the user plays an operator of the musical instrument (e.g., an intensity of depression of a key). The phrase “sound intensity” refers to an intensity of musical sound output (played back) in response to playing of the musical instrument by the user (e.g., a volume). For example, the intensity characteristic refers to a touch curve (velocity curve) that represents a relationship between the playing intensity and the sound intensity.

The term “habit data” is data in any appropriate format that indicates a playing habit of the user in playing the musical instrument. The habit data indicates a playing habit of the user in playing the musical instrument, examples of which include a habit in depressing a key with a finger. A “finger” of the user includes a thumb, index finger, middle finger, ring finger and little finger.

The “trained model” is a statistical estimation model that learns the relationship between training habit data and training correction data by machine learning. Under a potential relationship (ground truth) between the training habit data and the training correction data, the trained model outputs statistically reasonable correction data for unknown habit data.

In a specific example (Aspect 2) according to Aspect 1, the at least one processor further executes the program to set a second intensity characteristic by correcting the at least one first intensity characteristic using the correction data.

In a specific example (Aspect 3) according to Aspect 2, the at least one first intensity characteristic is provided in advance, and the second intensity characteristic reflects the playing habit of the user.

In a specific example (Aspect 4) according to any one of Aspects 1 to 3, the habit data is indicative of at least one playing characteristic for an operator used in playing a piece of music by the user from among a plurality of operators.

According to this aspect, a second intensity characteristic can be set, which shows a playing characteristic for each operator. For example, the playing characteristic indicated by the habit data represents a user playing intensity of an operator, or a user timing error of the operator.

In a specific example (Aspect 5) according to Aspect 4, the at least one playing characteristic includes a combination of the operator and a finger of the user.

In this aspect, the habit data represents a playing characteristic for each combination of a user's finger and an operator. As a result, an appropriate intensity characteristic can be generated, which shows a user's playing habit relating to a finger used to play an operator (e.g., poor at playing a specific operator with a specific finger).

In a specific example (Aspect 6) according to any one of Aspects 1 to 5, the input data includes user playing data indicative of a time series of notes played by the user.

In this aspect, a second intensity characteristic can be generated, which shows a user's playing habit.

In a specific example (Aspect 7) according to any one of Aspects 1 to 6, the at least one first intensity characteristic comprises a plurality of first intensity characteristics, each first intensity characteristic of the plurality of first intensity characteristics corresponding to a different tone, and the at least one processor further executes the program to correct, using the correction data, a first intensity characteristic that corresponds to a tone selected by the user from among the plurality of first intensity characteristics.

In this aspect, a first intensity characteristic that corresponds to the tone selected by the user is corrected by the correction data. As a result, a second intensity characteristic appropriate for each tone can be set.

In a specific example (Aspect 8) according to any one of aspects 1 to 6, the at least one first intensity characteristic comprises a plurality of first intensity characteristics, each first intensity characteristic of the plurality of first intensity characteristics corresponding to a different music genre, and the at least one processor further executes the program to correct, using the correction data, a first intensity characteristic that corresponds to a music genre selected by the user from among the plurality of first intensity characteristics.

In this aspect, the first intensity characteristic that corresponds to the music genre selected by the user is corrected by the correction data. As a result, an appropriate second intensity characteristic can be set for each music genre.

In a specific example (Aspect 9) according to any one of Aspects 1 to 8, the at least one trained model comprises a plurality of trained models, each trained model of the plurality of trained models corresponding to a different tone, and the at least one processor further executes the program to generate the correction data, using a trained model that corresponds to a tone selected by the user from among the plurality of trained models.

In this aspect, the trained model that corresponds to the tone selected by the user is used to generate the correction data. As a result, an appropriate second intensity characteristic can be set for each tone.

In a specific example (Aspect 10) according to any one of aspects 1 to 8, the at least one trained model comprises a plurality of trained models, each trained model of the plurality of trained models corresponding to a different music genre, and the at least one processor further executes the program to generate the correction data, using a trained model that corresponds to a music genre selected by the user from among the plurality of trained models

In this aspect, a trained model that corresponds to the music genre selected by the user is used to generate the correction data. As a result, an appropriate second intensity characteristic can be set for each music genre.

An electronic musical instrument according to one aspect (Aspect 11) of this disclosure includes: (a) at least one memory that stores a program; (b) at least one processor that executes the program to: acquire input data that includes habit data indicative of a playing habit of a user in playing the electronic musical instrument; generate correction data by inputting the acquired input data into at least one trained model that learns a relationship between training input data and training correction data; correct, using the generated correction data, at least one first intensity characteristic representative of a relationship between: (i) a playing intensity in playing the electronic musical instrument by the user; and (ii) a sound intensity of a musical sound output in response to playing of the electronic musical instrument; and set a second intensity characteristic by correcting the at least one first intensity characteristic; (c) a playing device configured to receive playing input by the user; and (d) a playback controller configured to control a playback system to play back a musical sound dependent on the received playing input using the second intensity characteristic.

The term “playing device” is a freely selected device (element) that is played by the user to play a musical instrument, such as a musical keyboard, or keys in a wind instrument.

In a specific example (Aspect 12) according to Aspect 12, the playing device includes: an operator that is displaced when played by the user; a signal generator that includes a first coil that receives a periodic reference signal; and a detectable portion disposed on the operator, the detectable portion includes a second coil that generates an induced current caused by electromagnetic induction due to a magnetic field generated in the first coil in response to supply of the periodic reference signal to the first coil, and the signal generator is configured to output a detection signal with a level dependent on a distance between the first coil and the second coil.

According to this aspect, it is possible to detect the displacement of the manipulation operator with high accuracy and with a simple configuration.

An computer-implemented information processing method according to one aspect (Aspect 13) of this disclosure includes: acquiring input data that includes habit data indicative of a playing habit of a user in playing a musical instrument; generating correction data by inputting the acquired input data into at least one trained model that learns a relationship between training input data and training correction data; and correcting, using the generated correction data, at least one first intensity characteristic representative of a relationship between: (i) a playing intensity in playing the musical instrument by the user; and (ii) a sound intensity of a musical sound output in response to playing the musical instrument.

A computer-implemented training model generating method according to one aspect (Aspect 14) of this disclosure includes: acquiring a plurality of training data including a combination of: (i) training input data that includes habit data indicative of a playing habit of a player in playing a musical instrument; and (ii) training correction data to correct an intensity characteristic, wherein the intensity characteristic represents a relationship between: (i) a playing intensity in playing the musical instrument by the player; and (ii) a sound intensity of a musical sound output in response to playing of the musical instrument, and establishing, by machine learning using the plurality of training data, at least one trained model that learns a relationship between the training input data and the training correction data.

### DESCRIPTION OF REFERENCES SIGNS

10 musical instrument, 11, 41, 61 and 66 . . . controller, 12, 42, 62 and 67 . . . storage device, 13, 43 and 63 . . . communication device, 14 . . . input device, 15 . . . playing device, 151 . . . keys, 152 . . . fulcrum, 153 . . . support member, 16 . . . sound source device, 17 . . . sound emitting device, 18 . . . playback system, 30 . . . characteristic setting section, 31 . . . acquirer, 32 . . . generator, 33 . . . corrector, 34 . . . playback controller, 40 . . . machine learning system, 51 . . . acquire, 52 . . . learning section, 60 . . . control system, 65 . . . computing device, 70 . . . detector, 71 . . . signal generator, and 72 . . . detectable portion.

What is claimed is:

1. An information processing system comprising:
at least one memory that stores a program; and
at least one processor that executes the program to:
acquire input data that includes habit data indicative of a playing habit of a user in playing a musical instrument;
generate correction data by inputting the acquired input data into at least one trained model that learns a relationship between training input data and training correction data; and
correct, using the generated correction data, at least one first intensity characteristic representative of a relationship between:
a playing intensity in playing the musical instrument by the user; and
a sound intensity of a musical sound output in response to playing of the musical instrument.

2. The information processing system according to claim 1, wherein the at least one processor further executes the program to set a second intensity characteristic by correcting the at least one first intensity characteristic using the correction data.

3. The information processing system according to claim 2, wherein:
the at least one first intensity characteristic is provided in advance, and
the second intensity characteristic reflects the playing habit of the user.

4. The information processing system according to claim 1, wherein the habit data is indicative of at least one playing characteristic for an operator used in playing a piece of music by the user from among a plurality of operators.

5. The information processing system according to claim 4, wherein the at least one playing characteristic includes a combination of the operator and a finger of the user.

6. The information processing system according to claim 1, wherein the input data includes user playing data indicative of a time series of notes played by the user.

7. The information processing system according to claim 1, wherein:
the at least one first intensity characteristic comprises a plurality of first intensity characteristics, each first intensity characteristic of the plurality of first intensity characteristics corresponding to a different tone, and
the at least one processor further executes the program to correct, using the correction data, a first intensity characteristic that corresponds to a tone selected by the user from among the plurality of first intensity characteristics.

8. The information processing system according to claim 1, wherein:
the at least one first intensity characteristic comprises a plurality of first intensity characteristics, each first intensity characteristic of the plurality of first intensity characteristics corresponding to a different music genre, and
the at least one processor further executes the program to correct, using the correction data, a first intensity characteristic that corresponds to a music genre selected by the user from among the plurality of first intensity characteristics.

9. The information processing system according to claim 1, wherein:
the at least one trained model comprises a plurality of trained models, each trained model of the plurality of trained models corresponding to a different tone, and
the at least one processor further executes the program to generate the correction data, using a trained model that corresponds to a tone selected by the user from among the plurality of trained models.

10. The information processing system according to claim 1, wherein:
the at least one trained model comprises a plurality of trained models, each trained model of the plurality of trained models corresponding to a different music genre, and
the at least one processor further executes the program to generate the correction data, using a trained model that corresponds to a music genre selected by the user from among the plurality of trained models.

11. An electronic musical instrument comprising:
at least one memory that stores a program;
at least one processor that executes the program to:
acquire input data that includes habit data indicative of a playing habit of a user in playing the electronic musical instrument;
generate correction data by inputting the acquired input data into at least one trained model that learns a relationship between training input data and training correction data;
correct, using the generated correction data, at least one first intensity characteristic representative of a relationship between:
a playing intensity in playing the electronic musical instrument by the user; and
a sound intensity of a musical sound output in response to playing of the electronic musical instrument; and
set a second intensity characteristic by correcting the at least one first intensity characteristic;
a playing device configured to receive playing input by the user; and
a playback controller configured to control a playback system to play back a musical sound dependent on the received playing input using the second intensity characteristic.

12. The electronic musical instrument according to claim 11, wherein:
the playing device includes:
an operator that is displaced when played by the user;
a signal generator that includes a first coil that receives a periodic reference signal; and
a detectable portion disposed on the operator,
the detectable portion includes a second coil that generates an induced current caused by electromagnetic induction due to a magnetic field generated in the first coil in response to supply of the periodic reference signal to the first coil, and
the signal generator is configured to output a detection signal with a level dependent on a distance between the first coil and the second coil.

13. A computer-implemented information processing method comprising:
acquiring input data that includes habit data indicative of a playing habit of a user in playing a musical instrument;
generating correction data by inputting the acquired input data into at least one trained model that learns a relationship between training input data and training correction data; and
correcting, using the generated correction data, at least one first intensity characteristic representative of a relationship between:
a playing intensity in playing the musical instrument by the user; and
a sound intensity of a musical sound output in response to playing of the musical instrument.

14. The computer-implemented information processing method according to claim 13, further comprising setting a second intensity characteristic by correcting the at least one first intensity characteristic.

15. The computer-implemented information processing method according to claim 13, wherein the habit data is indicative of at least one playing characteristic for an operator used in playing a piece of music by the user from among a plurality of operators.

16. The computer-implemented information processing method according to claim 15, wherein the at least one playing characteristic includes a combination of the operator and a finger of the user.

17. The computer-implemented information processing method according to claim 13, wherein the input data includes user playing data indicative of a time series of notes played by the user.

18. The computer-implemented information processing method according to claim 13, wherein:
the at least one first intensity characteristic comprises a plurality of first intensity characteristics, each first intensity characteristic of the plurality of first intensity characteristics corresponding to a different tone, and
the correcting corrects, using the generated correction data, a first intensity characteristic that corresponds to a tone selected by the user, from among the plurality of first intensity characteristics.

19. A computer-implemented training model generating method comprising:
acquiring a plurality of training data including a combination of:
training input data that includes habit data indicative of a playing habit of a player in playing a musical instrument; and
training correction data to correct an intensity characteristic, wherein the intensity characteristic represents a relationship between:
a playing intensity in playing the musical instrument by the player; and
a sound intensity of a musical sound output in response to playing of the musical instrument, and
establishing, by machine learning using the plurality of training data, at least one trained model that learns a relationship between the training input data and the training correction data.
